(19) United States
(12) Patent Application Publication
(10) Pub. No.: US 2007/0074614 A1
(43) Pub. Date: Apr. 5, 2007

(54) Light duty, long axis, portable, suspension cutter

(76) Inventors: Martin M. Sobel, Flemington, NJ (US); Shelly Sobel, Flemington, NJ (US)

Correspondence Address: Kenneth P. Glynn, 24 Mine Street, Flemington, NJ, 08822, US

(21) Appl. No.: 11/633,259

(22) Filed: Dec. 4, 2006

Related U.S. Application Data
(63) Continuation-in-part of application No. 10/941,391, filed on Sep. 15, 2004, now abandoned.

(51) Int. Cl. B26D 1/04

(52) U.S. Cl. 83/614

(57) ABSTRACT

A light duty, long axis, portable, suspension linear cutter includes a base member having a flat top and an elongated recessed cutting channel and an elongated housing guide connected to suspension towers by suspension mechanism(s) with a gap between the base member and the elongated housing guide so as to position a sheet to be cut atop the base member and under the elongated housing guide. The elongated housing guide is parallel to the channel, and has a track component adapted to receive a corresponding track component of the main blade housing. The main blade housing is adapted to move along the elongated housing guide parallel to the channel. It has a handle and a knife holder adapted to receive and hold a blade.

### REFERENCES TO RELATED APPLICATIONS

This application is a continuation-in-part of copending U.S. patent application Ser. No. 10/941,391 filed on Sep. 15, 2004, entitled “Light Duty, Long Axis Portable Cutter”, having an Attorney Docket No. MMS-101A, by the same inventor herein.

### BACKGROUND OF THE INVENTION

1. Field of the Invention

The present invention relates to portable cutters that include a base member, a housing guide, a housing and a knife holder on the housing. The knife holder is adapted to receive and hold a box cutter knife (with handle and blade), wherein the box cutter knife is removable and blades are removable, replaceable, or interchangeable. The device may be a stand alone, with its own table structure, a stand alone for placements on a table, desk or other structure, or maybe one that is removably attached to a table, desk or other structure.

2. Information Disclosure Statement

The following patents are representative prior art references relating to cutters:

U.S. Pat. No. 6,134,999 relates to a trimming station for sheet like articles comprising a first conveyor assembly conveying sheet material in a first orientation having a first trimming section with vibrating trimming elements. Further, a sheet material reorienting section is provided for the sheet material. Reoriented sheet material articles are conveyed in a second orientation to a second conveyor assembly having a second trimming section with trimming elements.

U.S. Pat. No. 6,098,515 describes an improved rotary trimmer having a blade biasing member. The biasing member biases the blade in an inoperative position in which the blade is retracted inside a housing when not in use. A manual actuating means is used to overcome the bias provided by the biasing member and to move the blade into an operative position in which at least the cutting edge of the blade projects from the housing.

U.S. Pat. No. 5,996,459 describes paper cutter or trimming device that comprises a cutting board including measuring indicia, rail assembly, and a carriage assembly including a circular blade. The indicia are calibrated in a scale measured from a predetermined cut line. The rail assembly is mounted in a perpendicular relation to the measuring indicia for pivotal movement between operative and inoperative positions with respect to the cutting board. The carriage assembly is mounted for sliding movement on the rail assembly. The cutting board may include a positive stop, and the rail assembly may be biased against the at least one stop when the rail assembly moves to the operative position.

U.S. Pat. No. 5,819,618 describes a rotary paper trimmer for cutting sheet material and a method of using the trimmer. The rotary paper trimmer has a base, a pressure pad, and a blade holder assembly. The pressure pad has a guide rail and a gear track attached to its upper surface. A blade holder assembly has an outer shell slideably attached to the guide rail, a shaft rotatably attached to the shell, a circular blade attached to the shell and adjacent a lateral edge of the base, and a gear attached to the shaft. As the blade holder assembly is slid on the guide rail, the gear engages with the gear track and rotates the shaft and circular blade to cut sheet material inserted between the pressure pad and base.

U.S. Pat. No. 5,802,942 illustrates a paper trimmer that includes a base and a plate pivotally attached to the base. A carrier is slideably attached to the plate in an elongated slot. A blade assembly includes a blade secured to a blade holder. The blade assembly is received in a cavity formed in the carrier such that a cutting edge of the blade extends below the plate and is received within a channel formed in a cutting region of the base when the plate is disposed over the cutting region. A paper is cut by translation of the carrier along the slot of the plate.

U.S. Pat. No. 5,392,676 describes a device for trimming wallpaper, including champs for fastening the device to a flat surface, a rod for holding a roll of wallpaper, an adjustable stop to accommodate rolls of different widths, and a retainer to hold the wallpaper on a cutting surface adjacent to a slot in the cutting surface which accommodates a knife edge to allow the wallpaper to be served from the roll with a straight edge.

U.S. Pat. No. 5,271,305 describes a support assembly includes a base having end edges along which extend toothed racks for engagement of a clamping bar having meshing detents on its end portions, the clamping bar providing a guide track for a DIY mat cutter. The base is invertiable to present English system and metric system distance-measuring features on its opposite side surfaces.

U.S. Pat. No. 5,046,392 describes a method and apparatus for severing a length of insulating batting and simultaneously cutting only the insulating material thereof is provided. The insulating material between the severed edge of the insulation batting and the cutting line through the insulating material can be removed to expose a length of backing which can be secured to the uncut portion of the insulation batting length is wrapped around a length of heating and cooling duct or the like. The apparatus includes a pair of rotating cutting wheels rotatably mounted on a carriage movable along an elongate carriage rail. A pinion gear mounted to each rotating cutting wheel for rotation therewith meshes with a rack secured to the elongate carriage rail to cause rotation of the rotating cutting wheel to response to movement of the carriage along the carriage rail.

U.S. Pat. No. 4,867,023 describes a mat cutting machine that utilizes a trolley which runs smoothly and accurately along a shaft mounted upon the clamping bar assembly. Means is provided for precisely adjusting the relationship between the bevel cutting blade and the edge of the clamping bar, and the edge of the clamping bar, and the blades are held by magazines which permit ready interchangeability and facile adjustment of the amount of blade protrusion so as to enable the cutting depth to be altered with considerable ease. The base of the machine includes means for accurately positioning the workpiece, and for readily controlling the travel of the trolley, to afford high volume production capability.

U.S. Pat. No. 4,854,204 describes improvements in the life of cutting knife blades and the quality of shearing of thick multiple sheet and shingled paper products produced in a paper trimming system having two circular rotatable knives mounted to overlap at a shearing station through which the paper products are passed. Thin steel annular disc cutting blades with teeth about the outer circumference are significantly improved in life be eliminating the effects of blade warping and non-continuous mating contact with a bed knife cutting surface in an adjacent shearing relationship that is not broken by intervention of sheared paper or out of round knife surfaces or by deflection of the cutting blade away from mating surface contact by the pressure of thick or shingled paper products. Friction and wear is reduced by inclination of the cutting blade to prevent continuous rubbing against sheared paper edges. These problems are resolved by dishing and mounting the thin flexible annular disc cutting knife at a small angle away from perpendicular to the axes of rotation of the knives and by supporting its outer circumference to prevent deflection away from mating contact with the bed knife cutting surface. Thus, the cutting edges between the two rotary knives remain in continuous contact to produce clean cuts without raggedness in the presence of heavy loading form thick many paged paper products even when shingled to present a succession of step function increases of cutting loads.

U.S. Pat. No. 4,224,854 describes a cutting and scoring device and method wherein an elongated body is positioned on one face of a sheet to be worked, having a track extending along the body, a carriage movable along the rack, a tool holder carried by the carriage for movement therealong and located over the sheet, and a tool depending from the tool holder for working engagement with the sheet.

U.S. Pat. No. 3,996,827 describes a cutter for mat frames which includes a cutter head, including a pair of blade carrying cutter blocks, slideable along a cutter bar and having a plurality of adjustable stops for accurately positioning and cutting of a mat board without over or under cutting. The assembly also includes means to limit the depth of the cut by one of the cutter blocks and means to lock the other cutter block in cutting position. Also included in the cutter is an adjustable handle frame which includes a cutter bar along which the cutter head is guided.

U.S. Pat. No. 3,973,459 describes a mat bevel cutting method and apparatus having a pivotal mounted cutting guide rail in conjunction with sidewalls which serve to hold the matting material in place and squared during the cutting operation. The apparatus also includes built-in auxiliary measuring and alignment tools to facilitate accurate alignment and cutting.

U.S. Pat. No. 3,821,915 describes a mechanically driven, rotary blade cutting device for cutting various types of fibers and sheet materials. The device includes a rotary blade shaft-mounted on a carriage for transverse movement across the material to be cut. Along the carriage traverse is a sprocket chain to which the blade is coupled by means of a sprocket wheel on the end of its shaft. The rate of blade rotation as driven by the sprocket-gear arrangement develops a sawing or slicing action for increased effectiveness in cutting the materials involved. Handles are provided on the blade housing to permit propelling the carriage in either direction and from either side. The rack on which the unit is mounted has a support for rolls of sheet materials to be cut, is portable, and is arranged to be bench or wall mounted. The unit also includes a combination with the blade a particular blade sharpening mechanism comprising a pair of grinding wheels angled to develop the desired sharpened blade angle. The sharpening mechanism is pivoted for use as desired and, when in blade-engaging position, its rotary sharpening wheels are driven by the rotation of the blade itself to accomplish the sharpening as the cutting mechanism is operated.

U.S. Pat. No. 3,821,915 describes a device that is provided for trimming art mats and for cutting bevel edged apertures useful in picture mounting. A ways is mounted on a base plate and carries a sliding cutter block. A rod parallel with the ways supports travel limiting stops. One side of the block is arranged perpendicular to the base plate, while the other side thereof is arranged to slope relative thereto about 45 degrees. Both sides of the block mount knife plates assemblies which can be rotated to place their knives in or out of cutting position. When a knife is in a cutting position, a knife corner extends downwardly into clearance channels in the base to define the cutting pathways, whereby a clean cut entirely through the workpiece may accurately be made either square-edged with one knife plate or bevel-edged with the other.

U.S. Pat. No. 3,463,041 describes a picture mat cutter including a cutting knife carried in a carriage which is mounted upon a pair of shafts. One of the shafts is fixed in bearings while the second shaft is supported upon and lies upon extensions of the bearings. No part of the cutter, except the knife and the base touches the mat.

U.S. Pat. No. 3,301,117 describes an apparatus for cutting sheet material comprising a rigid extruded guide bar member formed with a base a web portion extending upwardly from said base and being formed with a bead along its upper edge, a blade holder mounted at one side of said web portion and having slideably interlocking engagement with said base and bead, a cutter blade detachably secured to said blade holder and having a cutting edge extending below said base.

U.S. Pat. No. 3,237,497 describes a device for cutting paper and the like, comprising an elongated base member having a blade receiving slot extending longitudinally of the upper surface thereof for reciprocal passage of a cutting blade therein; and elongated paper clamp extending substantially the length of said base member above and parallel with said upper surface thereof and adjacent to one side of said slot. A pair of posts rigidly secured to opposite ends of said base member and extending upwardly therefrom and in which the opposite ends of said clamp are vertically reciprocal for movement toward and from said base member for clamping and releasing paper between said clamp and said base member. A horizontally elongated clamp actuator spaced above and parallel to said clamp; said actuator being supported on said posts for horizontally reciprocal movement longitudinally of said clamps; means connecting said clamp and said actuator at a plurality of horizontally spaced points intermediate said posts for uniform vertical movement of said clamp towards said base member to a paper clamping position upon horizontal movement of said actuator in one direction and for uniform vertical movement of said clamp away from said base member upon horizontal movement of said actuator on the other direction; a blade carriage having a blade thereon extending into said slot and adjacent to said clamp for cutting paper when said clamp is in said paper clamping position; means secured between said posts for supporting said blade carrier for horizontally reciprocal movement substantially from post to post at either end of said base member.

Notwithstanding the prior art, the present invention is neither taught nor rendered obvious thereby.

### SUMMARY OF THE INVENTION

A light duty, long axis, portable, suspension, linear cutter, which comprises: (a) a base member having a flat top and an elongated recessed cutting channel, and having a first end and a second end and having a suspension tower at each of the first end and the second end for supporting an elongated housing guide in a suspended fashion; (b) the elongated housing guide having a first end and a second end, and being connected to a suspension tower at its first end and to a suspension tower at its second end, both connections being via suspension means with a gap between the base member and the elongated housing guide so as to position a sheet to be cut atop the base member and under the elongated housing guide, the elongated housing guide being parallel to the recessed cutting channel of the base member, the elongated housing guide having at least one track component selected from one of a male track component and a female track component, and adapted to receive the other of a male track component and a female track component of a main blade housing; (c) the suspension means having two suspension units, one of each being functionally connected at the first end and at the second end of the elongated housing guide, and one of each being connected to the suspension tower at the first end and the second end of the base member, each of the suspension units adapted to hold the elongated housing guide in a first rest position, being an elevated position above the base member, adapted to permit vertical movement of the elongated housing guide to a lower position below the first rest position for cutting, by downward pressure upon the elongated housing guide and adapted to return the elongated housing guide back to its first rest position by vertical movement when the downward pressure is released; (d) a main blade housing adapted to move along the elongated housing guide parallel to the channel, the main blade housing having a handle, having at least one track component selected from one of a male track component and a female track component moveably connected to the housing guide, and having a knife holder adapted to receive and hold a cutting knife.

In some preferred embodiments of the present invention, the light duty, long axis, portable, suspension, linear cutter the base member has two opposing sections and the channel is established by a void between the two opposing sections.

In some preferred embodiments of the present invention, the light duty, long axis, portable, suspension, linear cutter the two opposing sections have horizontal plates with downwardly extending vertical plates with the channel therebetween.

In some preferred embodiments of the present invention, the light duty, long axis, portable, suspension, linear cutter the elongated guide and the main blade housing each have at least two of the track components and the track components of the elongated guide are complementary to the track components of the main blade housing.

In some preferred embodiments of the present invention, the light duty, long axis, portable, suspension, linear cutter the base member includes an alignment and measuring grid.

In some preferred embodiments of the present invention, the light duty, long axis, portable, suspension, linear cutter the base member includes a squaring fence.

In some preferred embodiments of the present invention, the light duty, long axis, portable, suspension, linear cutter the base member includes attachment means for portable, removable attachment to a table.

In some preferred embodiments of the present invention, the light duty, long axis, portable, suspension, linear cutter the attachment means is at least one clamp.

In some preferred embodiments of the present invention, the light duty, long axis, portable, suspension, linear cutter the main blade housing includes an inverted U-shaped portion moveably nested about the elongated housing guide.

In some preferred embodiments of the present invention, the light duty, long axis, portable, suspension, linear cutter the knife holder includes a knife slider controller for adjustment of knife blade height.

In some preferred embodiments of the present invention, the light duty, long axis, portable, suspension, linear cutter the base has a drop off shelf to aid in clean cutting.

In some preferred embodiments of the present invention, the light duty, long axis, portable, suspension, linear cutter the towers and the suspension units include height adjustment components to provide elongated housing guide height adjustment capability.

In some preferred embodiments of the present invention, the light duty, long axis, portable, suspension, linear cutter the suspension units are selected from the group consisting of magnets, suspension springs, leaf springs, reel springs and counterweights.

In some preferred embodiments of the present invention, the light duty, long axis, portable, suspension, linear cutter the height adjustment means is a vertical adjustment controller that includes a manually rotatable screw and lock and the suspension units are threaded and functionally connected to the manually rotatable screw and lock.

In some preferred embodiments of the present invention, the light duty, long axis, portable, suspension, linear cutter the elongated guide and the main blade housing each have at least two of the track components and the track components of the elongated guide are complementary the track components of the main blade housing.

In some preferred embodiments of the present invention, the light duty, long axis, portable, suspension, linear cutter the main blade housing includes an inverted U-shaped portion moveably nested about the elongated housing guide.

In some preferred embodiments of the present invention, the light duty, long axis, portable, suspension, linear cutter the knife holder includes a knife slider controller for adjustment of knife blade height.

In some preferred embodiments of the present invention, the light duty, long axis, portable, suspension, linear cutter the channel is less than 15 inches in length.

In some preferred embodiments of the present invention, the light duty, long axis, portable, suspension, linear cutter the channel is at least 15 inches in length.

In some preferred embodiments of the present invention, the light duty, long axis, portable, suspension, linear cutter the main blade housing is removable from said elongated housing guide.

### BRIEF DESCRIPTION OF THE DRAWINGS

The present invention should be more fully understood when the specification herein is taken in conjunction with the drawings appended hereto wherein:

FIG. 1 shows a front perspective view of one embodiment of a preferred present invention light duty, long axis, portable, suspension, linear cutter;

FIGS. 2A and 2B illustrate partial front perspective views of the present invention. FIG. 1 cutter left end with the tower cover removed;

FIG. 3 shows a partial blown up front perspective view of the present invention portable cutter main blade housing shown in FIG. 1 with its components and blade;

FIGS. 4A, 4B, 4C, 4D and 4E show front views of the present invention light duty, long axis, portable, suspension, linear cutter of FIG. 1, in various stages of use;

FIG. 5 shows a block diagram overview of the light duty, long axis, portable, suspension, linear cutter;

FIG. 6 is an end view of another embodiment present invention portable cutter showing another guide, main blade housing and suspension tower arrangement; and,

FIG. 7 is an end view of yet another embodiment present invention portable cutter showing another guide, main blade housing and suspension tower arrangement.

### DETAILED DESCRIPTION OF THE PRESENT INVENTION

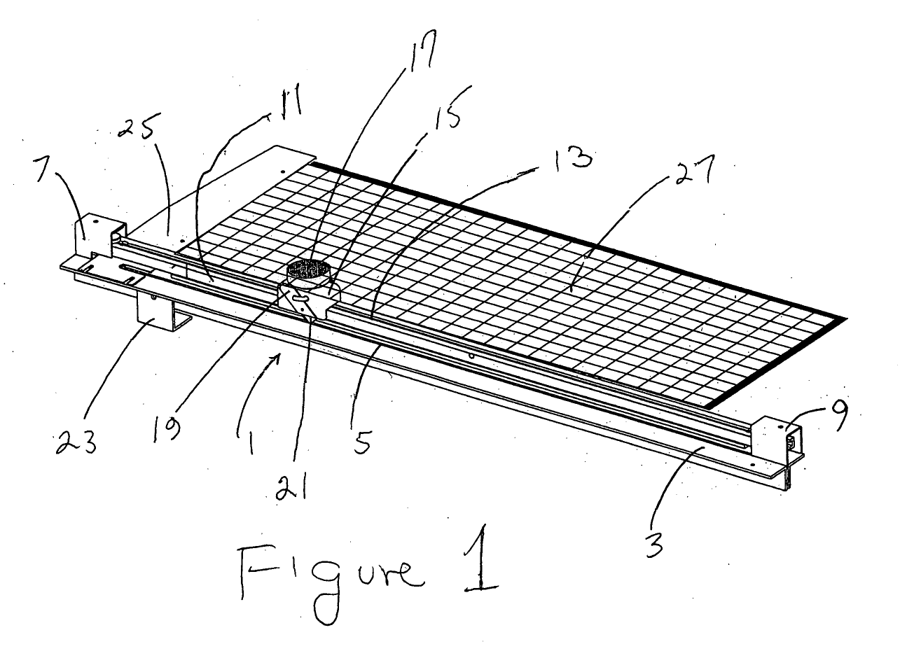

FIG. 1 illustrates a front perspective view of one embodiment of a preferred present invention light duty, long axis, portable, suspension, linear cutter 1. The cutter 1 includes a base member 3, in this case, a pair of opposing right angle aluminum bars adjoined with the front portion dropped down slightly to create a front drop down shelf. This drop down shelf allows an object to be cut (paper, cardboard, bristol board, plastic sheet, etc.) to drop away at the cut so as to reduce or eliminate cutting blade drag or snag. The two components of base member 3 also create a recessed cutting channel 5.

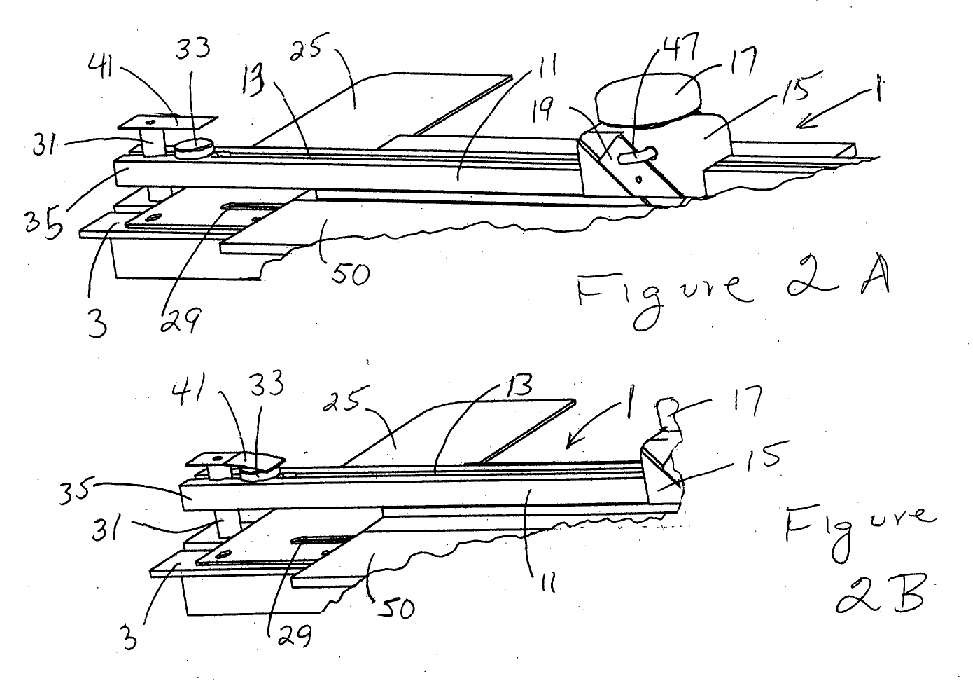

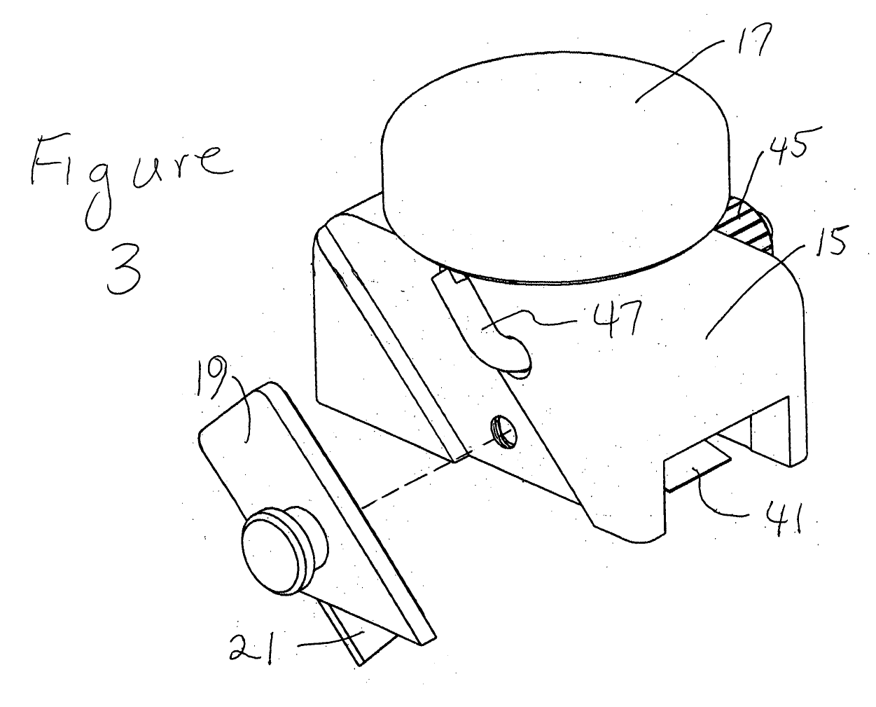

Cutter 1 has an elongated housing guide 11 that is supported by suspension towers at opposite ends. The towers are obstructed in this view by suspension tower covers 7 and 9, but these covers have been removed in FIGS. 2A and 2B, below, to illustrate what the tower is, and how it works, in this embodiment. Elongated housing guide 11 has a track 13 for maintaining and positioning main blade housing 15 in a linear movement mode to traverse guide 11 parallel to the base cutting channel 5. Main blade housing 15 has a knob handle 17 and a blade holder 19 for cutting blade 21. (Details are expanded upon with reference to FIG. 3 below.)

There is a table attachment means 23 and thus may be any type of clamping mechanism. The table attachment means 23 is an optional feature, as an alternative cutter could have a flat bottom for resting upon a table, without being secured to it. However, for certain types of uses, e.g. small plastic sign, photo lab, matting and framing, etc. a table mounted, secured, fixed cutter, with a table attachment means, is preferred.

Optional squaring fence 25 extends back at a right angle from the cutting channel 5 and is attached to the top of base member 3. It is used to place the right-angle-to-cutting edge of an object to get a square cut. It is an optional but preferred feature, as is grid 27. Grid 27 is attached to the base member 3 and may be laid out with inches or centimeters or both, with or without fractions thereof. This may aid a user in cutting an object to a predetermined size.

FIGS. 2A and 2B show a front perspective view of the FIG. 1, cutter 1, left side, and identical components are identically numbered. In both FIGS. 2A and 2B, the suspension tower cover 7 (FIG. 1) has been removed to show suspension tower 31 with top metal spring 41 and magnet 33. The spring 41 is attached to the top of tower 31 and the magnet 33 is affixed to the top of elongated housing guide 110. These two components spring 41 and magnet 33, constitute the suspension means in this embodiment.

In FIG. 2A, the guide 11 has been pushed down in a rest position wherein the magnet has been separated from the spring 41. This down mode may be a rest position when cutter 1 is not in use, but is also a down position for cutting, after an object to be cut has been inserted. In FIG. 2B, the guide 11 has been lifted up, the magnet 33 attaches to spring 41 and the guide 11 is held up to free the user's hands for placement thereunder for an object to be cut. Although only the left side cutter 1 has been shown and described in FIGS. 2A and 2B, the opposite end has the same set up under cover 9 (FIG. 1). It is the functionality of both towers and their suspension means that provides vertical motion of the entire guide 11, eliminating the imbalance and pressure variations that often occur in prior art swing arm (rotating) type cutter guides.

FIG. 3 shows a partial blown up front perspective view of the present invention portable cutter main blade housing 15 shown in FIG. 1 with its components and blade 21. It had a handle 17, blade holder 19, main blade housing lock 45, locking lever 47 and leaf spring 41, as shown. The blade 21 is placed on the blade holder 19 and they are placed in the recess on the side of housing 15 and screwed securely together.

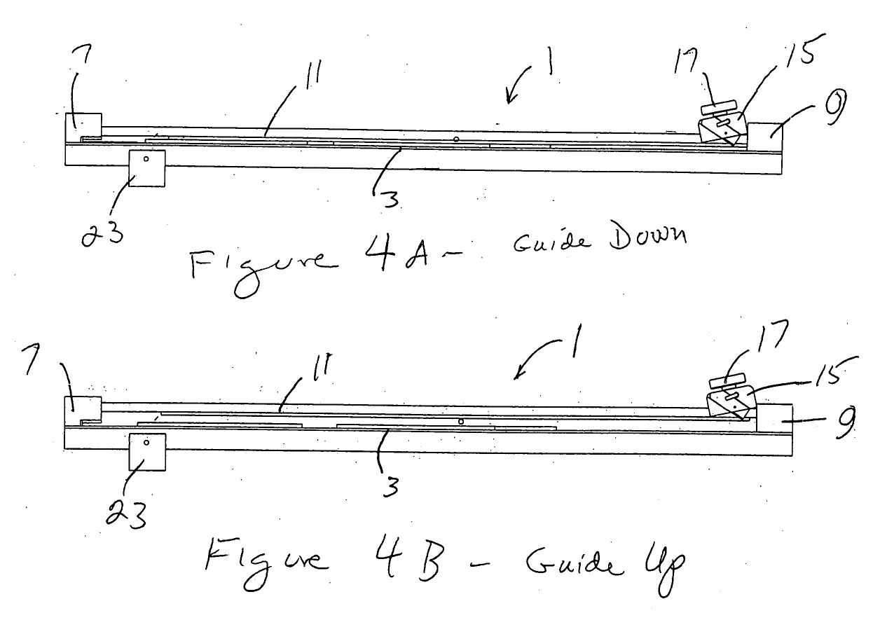

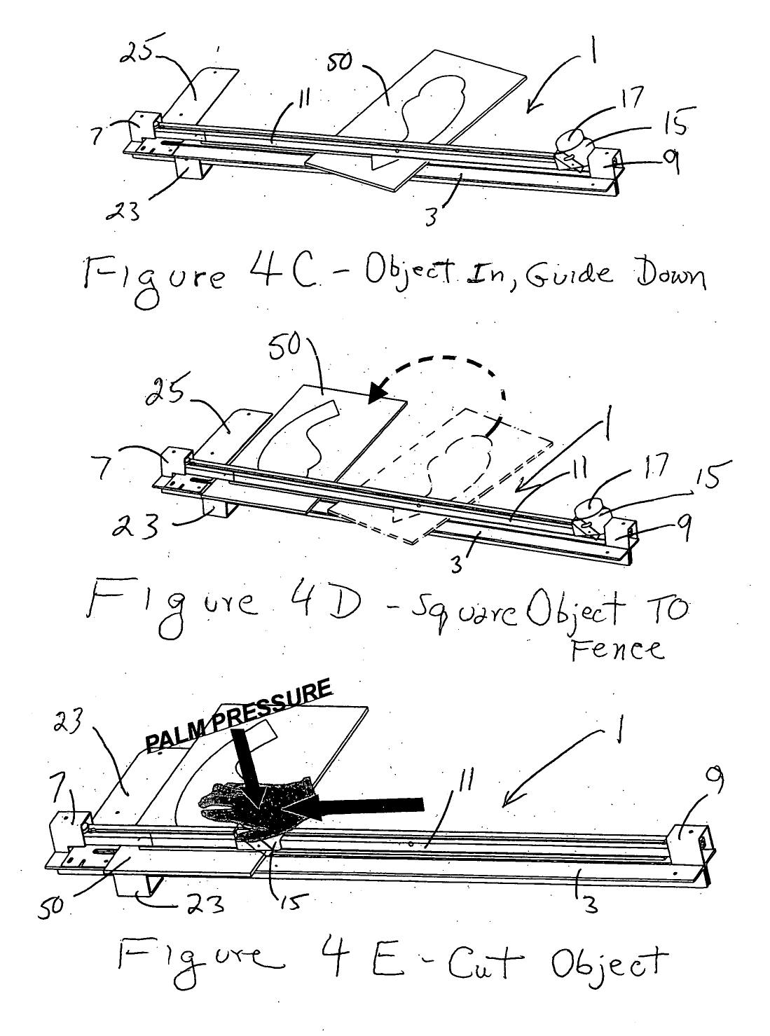

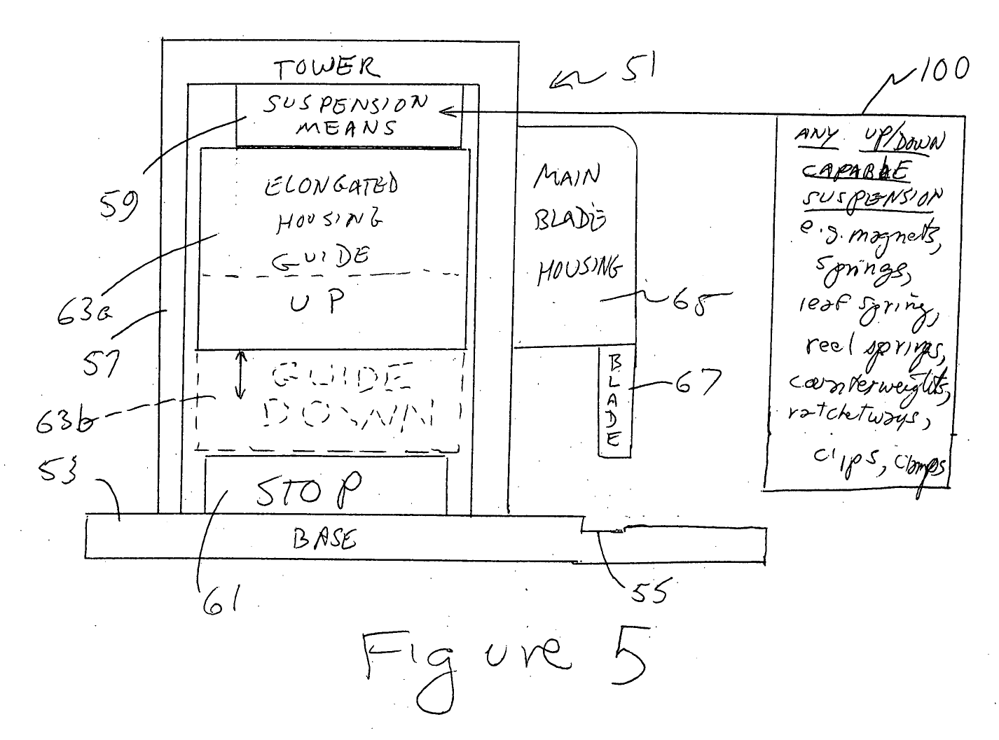

FIGS. 4A, 4B, 4C, 4D and 4E show front views of the present invention light duty, long axis, portable, suspension, linear cutter 1 of FIG. 1, in various stages of use. Identical parts are identically numbered from FIG. 1 to these Figures. In this preferred embodiment, the elongated housing guide 11 is, as mentioned above, vertically moveable via a the suspension mechanisms at the towers. In FIG. 4A, elongated housing guide 11 has been lowered to a rest position, which is also a cutting position when an object to be cut is in the device. In FIG. 4B, it has been raised to a non-rest, non-cutting position to permit insertion of thick stock or any cuttable object desired prior to cutting, especially difficult-to-cut long axis work pieces.

Slideably attached to elongated housing guide 11 is a main blade housing 15. Main blade housing 15 is able to slide from left to right, and vice versa, for cutting and return. It has a convenient handle 17 and has a blade holder, adapted to receive and hold a cutting knife or cutting blade, as described above. Elongated housing guide 11 is positioned parallel to the recessed cutting channel of base member 3 and appropriately positioned and aligned so that the cutting blade may move back and forth within recessed cutting channel. To facilitate the positioning of work pieces to be cut, in this embodiment, there is an optional, but preferred, work piece squaring fence 25 that functions as a guide rail.

In FIG. 4C, the operator places the material or object 50, to be cut, under the raised guide 11, and then guide 11 is lowered by pushing gently down on it. In FIG. 4D, with guide 11 down, the operator adjusts the object 50 to the desired cut position. The grid has been removed in these Figures to simplify the functionality of the cutter, but the grid could be used to set the length of object 50, or the object 50 could be marked or scored for cutting or the operator could eyeball the position if exacting dimensions are not required. The object 50 is placed against the fence 25 for squaring, if desired. In FIG. 4E, the object 50 is cut. As a result of the downward force and the linear force imposed by the operator on handle 17, the object 50 is easily and successfully cut without strong force, without error and without blade snags or tearing.

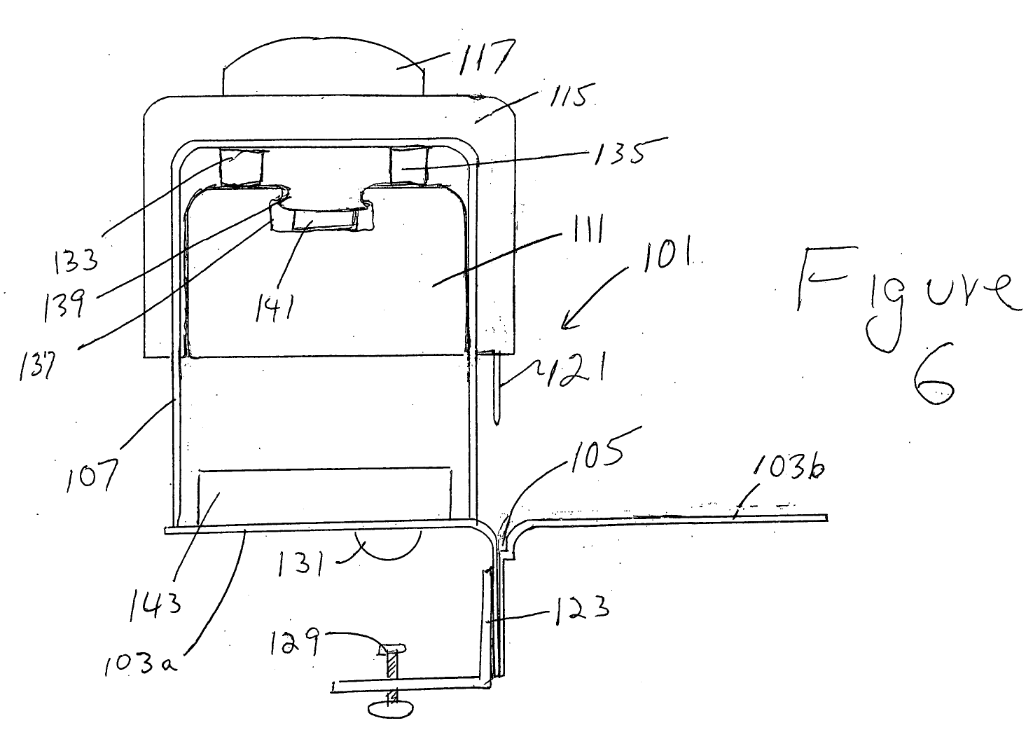

FIG. 5 shows a block diagram 51 of the present invention concept. Base member 53 may have any functional configuration and may be unistructurally molded, cast or formed or it may be an assemblage of parts. It will include a cutting channel 55 and an adjacent drop off shelf, as shown. Suspension tower 57 will support at least a portion of the suspension means 59 for suspending elongated housing guide 63a therefrom, as shown in solid lines in the up position, and guide 63b in the dashed lines in the down position. The tower 57 may be a bridge type tower or an upright, a post or rod or other erection from the base member. The main blade housing 65 with blade 67 aligned with the cutting channel 55 is preferably ergonomically correct and is mounted on the guide for linear reciprocal movement. Block 100 shows some of the suspension means choices, although those specifically illustrated herein above and below are preferred, and the FIGS. 2A and 2B embodiment is most preferred.

The present invention portable cutter, described above and below, may have an overall effective cutting length to accommodate short axis and long axis cutting of rectangular stock thus, it may have a 12 inch cutting run (capable of cutting the long axis of an 8 inch by 11½ inch work paper or other work piece, or 20 inch to accommodate stock up to that width, or 36 inch, 48 inch, 60 inch, 72 inch or other effective widths, as may be desired). Further, it may be placed between the ends of two tables, it may be bolted or otherwise attached, or it may be temporarily fixed. Alternatively, it may be attached to its own stand, such as a table saw or the like. In yet other embodiments, it may be permanently attached to a small table top (cutting block) made of wood, plastic, or other material. This could have a X-axis and a Y-axis scale in inches, centimeters or both and it could have a cross-hatched topography as is common with smaller “chop block” paper cutters.

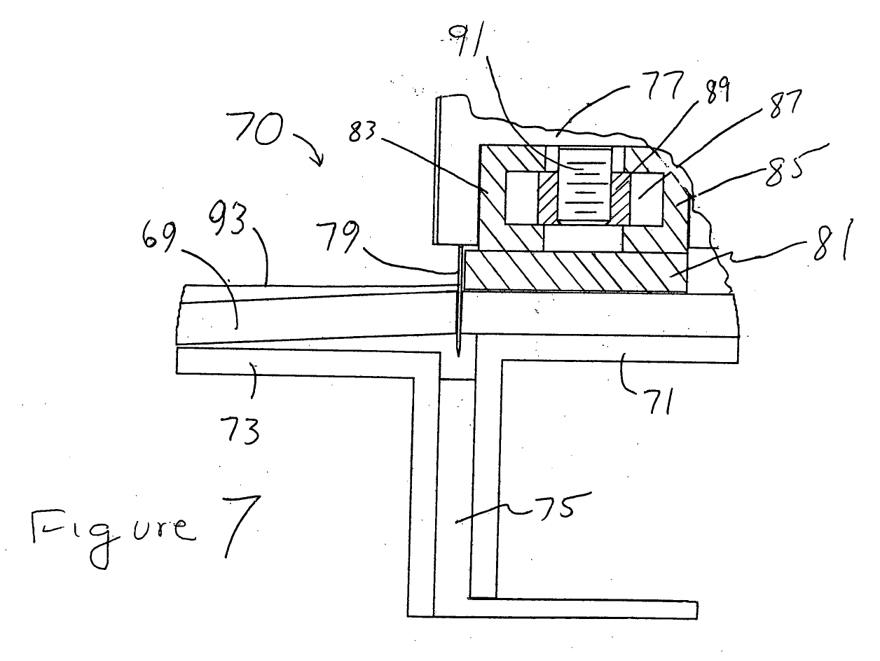

FIG. 6 shows a partial blown up end view of another present invention portable cutter 101. Cutter 101 has a base member that has a back right angle piece that is the main base support 103a for the functional parts of the cutter mechanism, and an opposing, connected, front right angle piece, shelf 103b. There is a slight drop off between the front and the back pieces and so that the front piece is a drop down shelf to aid the cutting process, as elaborated upon above, along with a cutting channel 105. Table attachment clamp, table attachment means 123 includes a screw lock attachment fastener 129 and an attachment cushion 131. The suspension tower 107 has magnets 133 and 135 at the inside top area and guide 111 is supported by the magnets 133 and 135 when the guide 111 is in the up position as shown, and pushed down and released from the magnets 133 and 135 onto rest 143 or an object to be cut when in the cutting position (down position). The main blade housing 115 has a handle 117, a male track rail 139 and a stabilizing spring 141 that fit into female track 137 of guide 111. The blade housing 115, with its blade 121, slides horizontally along the corresponding female track 137 of the guide 111; any number of tracks may be used as desired.

In FIG. 7, alternative embodiment present invention light duty, long axis, portable, linear cutter 70 is shown in an end view, with elongated housing guide 81 lowered onto object 69. The suspension tower has been removed to illustrate other features of the invention. Front base member drop down shelf is on the left side of the Figure and main base member 71 on the right. Angle piece attachment bracket 75 establishes a void thereabove that functions as a cutting channel so that the leading edge point of the blade 79 will easily travel below the object to be cut 69, in this case, a foam-based poster board. Blade 79 is removeably connected to main blade housing 77, which is slideably connected to the guide that is made up of the bottom section 81, front section elongated housing guide channel bar 83 and opposing spaced apart back section elongated housing guide channel bar 85. Main blade housingthrack guide nut 89 and main blade housing track bolt 91 maintain the housing 77 in track 87 for horizontal precise reciprocal movement.

In the present invention cutters, the guide support members and other components may screwed, bolted, welded, riveted, slot-fitted or otherwise connected. Right angle brackets aid to eliminate vibration and torquing and are, thus, preferred. Additionally, major components of present invention portable cutters may preferably be assembled to one another with hex screws or other fasteners to permit fabrication in sections as knock down assemblies to provide for compact shipping and storage when not in use. Thus, the nature of the construction allows the cutter to be fabricated in sections as knock down assemblies. This feature provides for cost saving with respect to shipping because the long cutters can be disassembled and shipped via package courier, as opposed to trucking.

The suspension means of the present invention cutter is an essential element thereof. In cases where the guide is vertically slideably connected to a vertical tower. Some play in the orifice or yoke is beneficial. This gives the elongated housing guide some balance shift-tilt room to avoid torquing and pinching or jerking down and allows easy self-adjustment and horizontal stabilization when pushed down by a user.

Obviously, numerous modifications and variations of the present invention are possible in light of the above teachings. It is therefore understood that within the scope of the appended claims, the invention may be practiced otherwise than as specifically described herein.

### INDEX OF REFERENCE NUMBERS

01 . . . light duty, long axis, portable, linear cutter
03 . . . base member
05 . . . cutting channel
07 . . . first suspension tower cover
09 . . . second suspension tower cover
11 . . . elongated housing guide
13 . . . elongated housing guide track
15 . . . main blade housing
17 . . . main blade housing handle
19 . . . blade holder
21 . . . blade
23 . . . table attachment means
25 . . . squaring fence
27 . . . grid
29 . . . fence cut out
31 . . . suspension tower
33 . . . magnet
35 . . . elongated housing guide first end
37 . . . female track
39 . . . male track rail
41 . . . leaf spring
43 . . . rest stop
45 . . . main blade housing lock
47 . . . locking lever
50 . . . object to be cut
51 . . . cutter block diagram
53 . . . base
55 . . . cutting channel
57 . . . first tower
59 . . . suspension means
61 . . . stop
63 a . . . elongated housing guide “up”
63 b . . . elongated housing guide “down”
65 . . . main blade housing
67 . . . blade
69 . . . object to be cut
70 . . . alternative embodiment present invention light duty, long axis, portable, linear cutter
71 . . . base member
73 . . . base member drop down shelf
75 . . . attachment bracket
77 . . . main blade housing
79 . . . blade
81 . . . elongated housing guide bottom section
83 . . . front section elongated housing guide channel bar
85 . . . back section elongated housing guide channel bar
87 . . . track
89 . . . main blade housing track guide nut
91 . . . main blade housing track bolt
93 . . . squaring fence
100 . . . suspension means detail
101 . . . light duty, long axis, portable, linear cutter
103 a . . . main base support
103 b . . . base drop down shelf
105 . . . cutting channel
107 . . . suspension tower
111 . . . elongated housing guide
115 . . . main blade housing
117 . . . main blade housing holder
121 . . . blade
123 . . . table attachment means
129 . . . attachment fastener
131 . . . attachment cushion
133 . . . magnet
135 . . . magnet
137 . . . female track
139 . . . male track rail
141 . . . stabilizing spring

What is claimed is:

1. A light duty, long axis, portable, suspension, linear cutter, which comprises:
(a) a base member having a flat top and an elongated recessed cutting channel, and having a first end and a second end and having a suspension tower at each of said first end and said second end for supporting an elongated housing guide in a suspended fashion;
(b) said elongated housing guide having a first end and a second end, and being connected to a suspension tower at its first end and to a suspension tower at its second end, both connections being via suspension means with a gap between said base member and said elongated housing guide so as to position a sheet to be cut atop said base member and under said elongated housing guide, said elongated housing guide being parallel to said recessed cutting channel of said base member, said elongated housing guide having at least one track component selected from one of a male track component and a female track component, and adapted to receive the other of a male track component and a female track component of a main blade housing;
(c) said suspension means having two suspension units, one of each being functionally connected at said first end and at said second end of said elongated housing guide, and one of each being connected to said suspension tower at said first end and said second end of said base member, each of said suspension units adapted to hold said elongated housing guide in a first rest position, being an elevated position above said base member, adapted to permit vertical movement of said elongated housing guide to a lower position below said first rest position for cutting, by downward pressure upon said elongated housing guide and adapted to return said elongated housing guide back to its first rest position by vertical movement when said downward pressure is released;
(d) a main blade housing adapted to move along said elongated housing guide parallel to said channel, said main blade housing having a handle, having at least one track component selected from one of a male track component and a female track component moveably connected to said housing guide, and having a knife holder adapted to receive and hold a cutting knife.

2. The light duty, long axis, portable, suspension, linear cutter of claim 1 wherein said base member has two opposing sections and said channel is established by a void between said two opposing sections.

3. The light duty, long axis, portable, suspension, linear cutter of claim 2 wherein said two opposing sections have horizontal plates with downwardly extending vertical plates with said channel therebetween.

4. The light duty, long axis, portable, suspension, linear cutter of claim 1 wherein said elongated guide and said main blade housing each have at least two of said track components and said track components of said elongated guide are complementary to said track components of said main blade housing.

5. The light duty, long axis, portable, suspension, linear cutter of claim 1 wherein said base member includes an alignment and measuring grid.

6. The light duty, long axis, portable, suspension, linear cutter of claim 1 wherein said base member includes a squaring fence.

7. The light duty, long axis, portable, suspension, linear cutter of claim 1 wherein said base member includes attachment means for portable, removable attachment to a table.

8. The light duty, long axis, portable, suspension, linear cutter of claim 7 wherein said attachment means is at least one clamp.

9. The light duty, long axis, portable, suspension, linear cutter of claim 1 wherein said main blade housing includes an inverted U-shaped portion moveably nested about said elongated housing guide.

10. The light duty, long axis, portable, suspension, linear cutter of claim 1 wherein said knife holder includes a knife slider controller for adjustment of knife blade height.

11. The light duty, long axis, portable, suspension, linear cutter of claim 1 wherein said base has a drop off shelf to aid in clean cutting.

12. The light duty, long axis, portable, suspension, linear cutter of claim 1 wherein said towers and said suspension units include height adjustment components to provide elongated housing guide height adjustment capability.

13. The light duty, long axis, portable, suspension, linear cutter of claim 1 wherein said suspension units are selected from the group consisting of magnets, suspension springs, leaf springs, reel springs and counterweights.

14. The light duty, long axis, portable, suspension, linear cutter of claim 12 wherein said height adjustment means is a vertical adjustment controller that includes a manually rotatable screw and lock and said suspension units are threaded and functionally connected to said manually rotatable screw and lock.

15. The light duty, long axis, portable, suspension, linear cutter of claim 13 wherein said elongated guide and said main blade housing each have at least two of said track components and said track components of said elongated guide are complementary to said track components of said main blade housing.

16. The light duty, long axis, portable, suspension, linear cutter of claim 13 wherein said main blade housing includes an inverted U-shaped portion moveably nested about said elongated housing guide.

17. The light duty, long axis, portable, suspension, linear cutter of claim 13 wherein said knife holder includes a knife slider controller for adjustment of knife blade height.

18. The light duty, long axis, portable, suspension, linear cutter of claim 1 wherein said channel is less than 15 inches in length.

19. The light duty, long axis, portable, suspension, linear cutter of claim 1 wherein said channel is at least 15 inches in length.

20. The light duty, long axis, portable, suspension, linear cutter of claim 1 wherein said main blade housing is removable from said elongated housing guide.
